(19) United States
(12) Patent Application Publication
(10) Pub. No.: US 2006/0064559 A1
(43) Pub. Date: Mar. 23, 2006

(54) Method and apparatus for storing data on storage media

(75) Inventor: Kishore Kaniyar Sampathkumar, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/227,069

(22) Filed: Sep. 16, 2005

(30) Foreign Application Priority Data
Sep. 18, 2004 (GB) 0420785.8

(51) Int. Cl. G06F 12/16

(52) U.S. Cl. 711/162

(57) ABSTRACT

A method is described where data is copied from a plurality of first discrete physical storage means to a plurality of second discrete physical storage means, where the data is split across the plurality of first discrete physical storage means, the method comprising the steps of copying blocks of the split data in parallel between a plurality of pairs of said first and second discrete physical storage means, wherein the copying is performed in such a way that there is no more than one copy process occurring in respect of any single pair of first and second physical storage unit at any one time. The data may be split into blocks where each consecutive block is stored on a separate discrete physical storage means.

### FIELD OF THE INVENTION

The invention relates to methods and apparatus for storing data on storage media. More particularly, the invention relates to methods and apparatus for ensuring consistency and/or synchronizing data between units of storage media. To this end, a preferred embodiment of the invention relates to methods and apparatus for backing up and/or synchronising data volumes which are both striped and mirrored across a plurality of disks forming a distributed storage system.

### BACKGROUND TO THE INVENTION

According to present data storage paradigms, data stored on media is arranged in what are known as Logical Volumes or LVs. While the expression media contemplates hard disks, tape media, solid-state storage media etc, in the present specification we are generally more concerned with hard-disk (HD) media. This is not to be construed as a limitation however and the invention may be applied to other media types with appropriate adaptation.

A logical volume, or LV, is a discrete data storage unit which is logically recognized by the operating system of the system which incorporates the storage unit. A logical volume may not necessarily map to a unique physical disk. In some configurations, a logical volume may be spread across more than one physical unit of disk media.

An example of a single logical volume (logical volume 1 or LV-1) is shown in FIG. 1. Here, a unit of storage media in the form of a single physical disk 10 has 1000 blocks of data 11 arranged contiguously thereon. Block 1 of logical volume one (LV-1) is followed by block 2 of logical volume 1 up to block 1000 or LV-1. A single physical disk can contain more than one logical volume. For example, block 1000 or LV-1 can be followed by block one of logical volume 2 (LV-2) and so forth. Thus, from the point of view of the operating system, although the logical volumes may be configured as unique data storage units, they may coexist on a single or multiple physical disks.

One of the most important aspects of data storage techniques relates to data redundancy and error checking/correction. Single points of failure risks associated with storing only a single copy of data on a single physical disk can be mitigated using techniques such as mirroring and striping. Profound disk hardware failures will generally render a disk (or other storage media) completely or partially unreadable. Mirroring and striping attempt to remove this single point of failure and operate as follows.

A mirrored logical volume is one where data is replicated across more than one physical disk. That is, each block of a logical volume n has a counterpart block stored somewhere on the same or, more commonly, another physical disk. For practical reasons, the counterpart blocks are usually stored on another physical disk so that loss of a single disk will not render both copies unusable. Duplicating or mirroring blocks on the same physical disk can reduce the risk of loss of data due to block-level errors on the disk surface. Such errors do not always render the whole disk unusable.

Each copy of a complete logical volume is referred to as a “mirror” copy or simply as a mirror. If there are two mirror copies (as in the original and the copy), then it is said that the LV is 2-way mirrored. If there are three copies, it is 3-way mirrored etc.

The simplest mirroring situation is one where two physical disks each store data for the same LV. In such a case, there is a primary copy LV which is mirrored, or duplicated, on a separate physical disk. The disks are periodically synchronised whereby one LV can be considered as a master copy and a backup LV is “refreshed” based on changes or updates made to the master LV. In practice however, both the copies are “peers”, and there does not exist a master copy and a backup copy. Read I/O requests issued can be directed to any copy and writes can be directed to both the copies. What is important is that at any one time, consistent, identical copies of the data are stored on physically separate storage media.

In the event of a disk failure, the data will be preserved to the extent that the data has been most recently backed up, i.e. the mirrors synchronized.

Two mirrored volumes LV-1 and LV-2 are shown in FIG. 4. These reside on a single physical disk: Disk-1. These are synchronized as follows. In this example we assume that Mirror-1 is the master copy and holds the current data and Mirror-2 carries the stale data and needs to be synchronised. That is, the data in Mirror-2 of LV-1 residing on physical Disk-2 needs to be synchronised with the data in Mirror-1 of LV-1 that resides on physical Disk-1, and data in Mirror-2 of LV-2 residing on physical Disk-2 needs to be synchronised with the data in Mirror-1 of LV-2 that resides on physical Disk-1. It is also assumed that LV-1 consists of m blocks and LV-2 consists of n blocks of data and that n>m.

Logical volume resynchronization tasks are scheduled in parallel so that statistically the all data has an equal chance of being consistent between the two volumes at any point in time. Thus, there would be two independent tasks or processes, P1 and P2 performing corresponding operations simultaneously. P1 synchronises Mirror-2 of LV-1 on disk 2 with Mirror-1 of LV-2 on Disk-1 and P2 synchronises Mirror-2 of LV-2 on Disk-2 with Mirror-1 of LV-2 on Disk-1. Each of the synchronisation processes P1 and P2 syncs all of the data blocks in their respective volumes. The actual steps in the syncing process are as follows. Since P1 and P2 are executing in parallel, the following sequence of sub-operations are possible:
P1 syncs block 1 of m in LV-1
P2 syncs block 1 of n in LV-2
P1 syncs block 2 of m in LV-1
P2 syncs block 2 of n in LV-2
   . . .
P1 syncs block m of m in LV-1
P2 syncs block m of n in LV-2
P1 syncs block m+1 of n in LV-2
   . . .
P2 syncs block n of m in LV-2

Block 1 of LV-1 and block 2 of LV-2 are at least m blocks distant. So, if the sub-operations during mirror syncing occur in the above sequence, every block of synchronisation on LV-1 is preceded by a disk-head seek movement of at least 2m blocks. This is performed with at least m blocks in the forward direction and at least m blocks in the reverse direction, and vice versa for LV-2.

This excessive disk-head seeking movement can cause very poor mirror synchronisation performance. This can, under some circumstances, deteriorate even further as the number of unique logical volumes on the same physical disk increases.

In the case where the mirror copies which are to be synchronised simultaneously belong to two different LVs but reside on the same disk, seek times problems can be mitigated slightly by ensuring that recovery operations are started in a specific order that prevents two concurrent operations from involving the same disk. However, this condition cannot always be guaranteed.

Another method of avoiding single point of failures in storage media is a method known as Striping. A striped logical volume is one where the data in the LV is not stored contiguously on the same physical disk but is instead spread or “striped” across different disks in an ordered fashion. Thus, when data corruption occurs, block level reconstruction can be performed to retrieve the master copy, most current version, or surviving copy of the data from the data distributed across the disks.

Referring to FIG. 2, we consider a single LV (LV-1) which has 1000 blocks of data. The data is striped across physical disks 21 and 22 as follows. Block 1 of logical volume 1 is written onto Disk-1. Block two is striped onto separate physical Disk-2. This type of block placement and associated mapping between blocks is called a “stripe” 23. Thus block 1 and block 2 on disk 21 and 22 is referred to as Stripe 1.

Block three of LV-1 is then located after block one on physical disk 21. Block 4 of LV-1 is then arranged contiguously after block 2 of LV-1 on Disk-2. This arrangement of blocks 3 and 4 corresponds to Stripe 2. Thus for a 1000 block logical volume, the last stripe, Stripe 500, corresponds to the arrangement of blocks 999 and 1000 striped onto Disk-1 and Disk2.

Data (blocks) that are spread across different disks and are addressable independently are called stripe units. The size of these stripe units is referred to as “stripe unit size”. Hence, in the example above, the stripe unit size is 1 block. Moreover, when referring to a particular disk, we refer to the resident data as Stripe Unit 1 of LV-1 on Disk 1, Stripe Unit 1 of LV-2 on Disk 2, and so on.

Logical volumes can be simultaneously striped and mirrored. In such cases, the logical volumes have the following characteristics: there is more than one mirror copy, with data on each mirror copy being striped across all of the disks over which the mirrors are defined or constructed; each of the mirrors is identical in size; each mirror copy is spread across the same number of disks; and each mirror copy has the same stripe unit size. For example if mirror 1 has a stripe unit size of 64 kilobytes, mirror 2 will also have a stripe unit size of 64 kilobytes.

Synchronization techniques as applied to mirrored logical volumes have been discussed above. However, in the case of LVs which are both striped and mirrored, the prior art techniques are not satisfactory. This is discussed in detail below in the context of contrasting the invention with an example prior art technique for performing such a synchronization. It is an object of the invention to provide an effective method of ensuring data consistency between storage media, and in particular, storage media having data which is simultaneously striped and mirrored across a plurality of physical units of storage media.

### DISCLOSURE OF THE INVENTION

In one aspect, the invention provides for a method of copying data from a plurality of first discrete physical storage means to a plurality of second discrete physical storage means where the data is split across the plurality of first discrete physical storage means, the method comprising the steps of copying blocks of the split data in parallel between a plurality of pairs of said first discrete physical storage means and corresponding second discrete storage means wherein the copying is preferably performed in such a way that there is no more than one copy process occurring in respect of any single pair of first and second physical storage unit at any one time.

The data may be split into blocks, each block being stored on a separate discrete physical storage means.

The blocks stored on any one first physical storage means are preferably copied to a corresponding second physical storage means consecutively, in a random order, or in an order optimized according to the physical characteristics of the storage means.

Preferably the physical storage means are hard disks.

A group of specified group of blocks preferably corresponds to a logical volume.

A logical volume may be spread across a plurality of physical storage means.

The plurality of first storage means preferably stores a plurality of logical volumes.

In a preferred embodiment, the copying step occurs so that the data stored on the plurality of second storage means is mirrored on the plurality of first storage means.

In a further aspect, the invention provides a method of providing redundant data storage comprising the method as hereinbefore defined applied to arrays of hard disks.

In yet a further aspect, the invention provides a method of recovering lost data in a disk array wherein on loss of one or more units of data at a storage location on a discrete storage means, backup data is copied to said storage location in accordance with the method as hereinbefore defined.

In yet another aspect, the invention provides for a disk array configured to operate in accordance with the method as hereinbefore defined.

In yet a further aspect, the invention provides for a computer program adapted to operate a storage array in accordance with the method as hereinbefore defined.

In a further aspect, the invention provides a data carrier adapted to store a computer program adapted to operate a computer in accordance with the method as hereinbefore defined.

In yet a further aspect, the invention provides a method of mirroring striped data from two or more first hard disks to two or more second hard disks comprising the steps of simultaneously copying blocks of data between each first and second disk pair, the method adapted such that each copying process between any pair of first and second disks is physically decoupled.

### BRIEF DESCRIPTION OF THE DRAWINGS

The invention will now be described by way of example only and with reference to the drawings in which:

FIG. 1: illustrates a single logical volume with contiguous block placement on the physical disk as known in the prior art;

FIG. 2: illustrates a single logical volume with its blocks striped across two physical disks as is known in the prior art;

FIG. 3: illustrates three two-way mirrored logical volumes striped across four disks according to an embodiment of the invention; and

FIG. 4: illustrates a single physical disk with two logical volumes each two-way mirrored according to an embodiment of the invention.

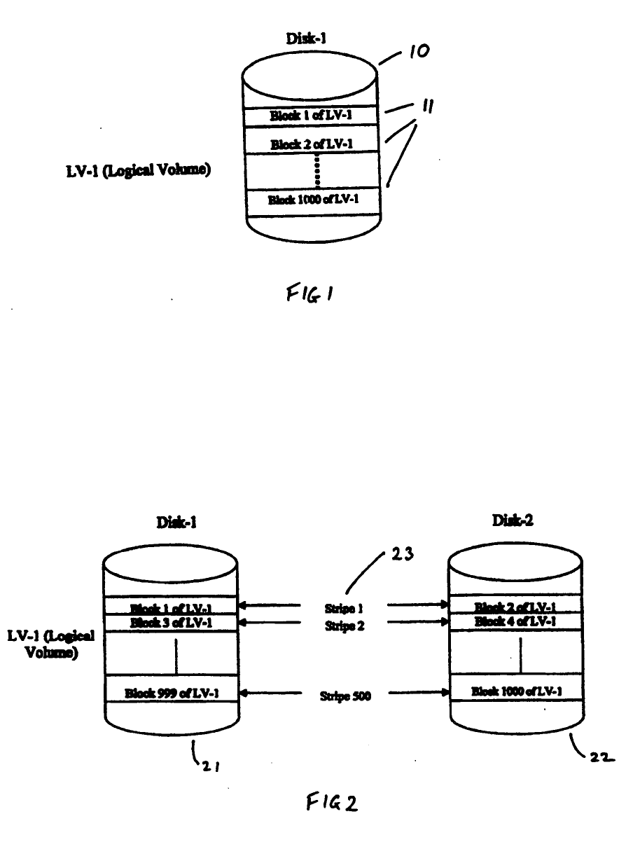

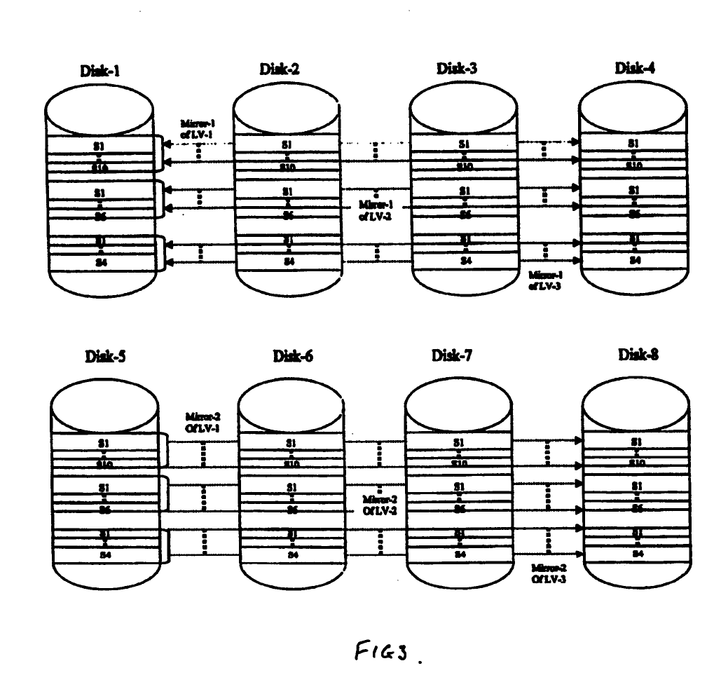

Broadly speaking and according to an exemplary embodiment, the invention operates so that data is copied from a plurality of first discrete physical storage means, the storage areas in the form of disks, to a plurality of second discrete physical storage means, again in the form of disks. The data is split, or striped, across the plurality of first discrete physical storage means. The blocks of the split data are copied in parallel between a plurality of first and second discrete physical storage means pairs. That is, the data is copied according to a pair-wise parallel copying process. However, the copying is performed in such a way that there is no more than one copy process occurring in respect of any single pair of first and second physical storage units at any one time, i.e., the copying occurs in a non-overlapping manner.

To illustrate the invention, it is useful to contrast existing techniques for synchronisation of volumes which are both mirrored and striped. Typically recovery or synchronization operations are started by having a single process per logical volume performing the synchronisation sequentially in a non-overlapping manner.

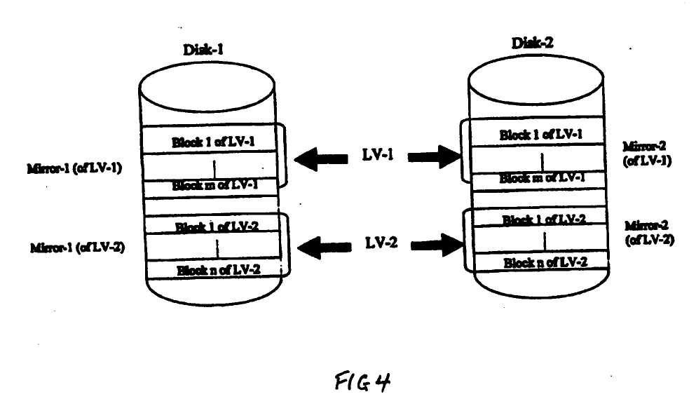

A combined mirroring/striping configuration is shown in FIG. 3. Here, an array of 8 physical disks, Disk-1 to Disk-8 is shown. Three logical volumes LV-1, LV-2 and LV-3 are each 2-way mirrored (Disk-1/5, Disk-2/6, Disk-3/7 and Disk-4/8) and striped (Disk-1/2/3/4 and Disk-5/6/7/8) across 4 disks. To clarify the nomenclature, by way of example S1 at the top left on Disk-1 refers to stripe 1 which is spread across four disks, Disk-1, 2, 3 and 4 and is mirrored on a second set of corresponding disks, Disk-5, 6, 7 and 8. So the mirrors of the LVs are arranged across physical disks Disk-5 to Disk-8.

Consider logical volume 1 (LV-1). The data belonging to this volume has 10 stripes (S1-S10). Stripe 1 of LV-1 corresponds to four consecutive data blocks spread, or striped, across 4 physical disks: Disk-1 to Disk-4. Thus mirror-1 of LV-1 consists of ten stripes spread across four disks. This data is then mirrored on disks Disk-5 through Disk-8 as mirror-2 (of LV-1).

So, reading FIG. 3 from top left to top right, mirror-1 in the form of stripes S1 to S10 of LV-1 is striped across disks Disk-1 to Disk-4. This data is mirrored in mirror-2 below, the mirror being striped across disks Disk-5 to Disk-8.

Similarly, logical volume 2 consisting of stripes S1 to S6 is spread across disks Disk-1 to Disk-4 as mirror-1 and is replicated across disks Disk-5 to Disk-8. Stripes S1 to S4 of logical volume 3 is similarly striped and mirrored across disks Disk-1 to Disk-4 and Disk-5 to Disk-8 respectively.

Applying the known method of synchronising logical volume data to a striped/mirrored disk array configuration of the type shown in FIG. 3, the synchronisation steps are as follows: For brevity, the following nomenclature is used. S1 is stripe-1, d5 is disk-5, m2 is mirror-2 and LV-1 is logical volume 1). So S1/d5/m2/LV-1->S1/d1/m1/LV-1 means copying the data block of Stripe 1 residing on disk 5, mirror 2 or logical volume 1 to the corresponding replicated block location on disk 1.

Step1

S1/d5/m2/LV-1->S1/d1/m1/LV-1
S1/d6/m2/LV-1->S1/d2/m1/LV-1
S1/d7/m2/LV-1->S1/d3/m1/LV-1
S1/d8/m2/LV-1->S1/d4/m1/LV-1
S2/d5/m2/LV-1->S1/d1/m1/LV-1
S2/d6/m2/LV-1->S1/d2/m1/LV-1
S2/d7/m2/LV-1->S1/d3/m1/LV-1
S2/d8/m2/LV-1->S1/d4/m1/LV-1
. . .
S10/d5/m2/LV-1->S10/d1/m1/LV-1
S10/d6/m2/LV-1->S10/d2/m1/LV-1
S10/d7/m2/LV-1->S10/d3/m1/LV-1
S10/d8/m2/LV-1->S10/d4/m1/LV-1

Each of the above operations is done in sequence by a single task/process.

Step2

S1/d5/m2/LV-2->S1/d1/m1/LV-2
S1/d6/m2/LV-2->S1/d2/m1/LV-2
S1/d7/m2/LV-2->S1/d3/m1/LV-2
S1/d8/m2/LV-2->S1/d4/m1/LV-2
S2/d5/m2/LV-2->S1/d1/m1/LV-2
S2/d6/m2/LV-2->S1/d2/m1/LV-2
S2/d7/m2/LV-2->S1/d3/m1/LV-2
S2/d8/m2/LV-2->S1/d4/m1/LV-2
. . .
S6/d5/m2/LV-2->S6/d1/m1/LV-2
S6/d6/m2/LV-2->S6/d2/m1/LV-2
S6/d7/m2/LV-2->S6/d3/m1/LV-2
S6/d8/m2/LV-2->S6/d4/m1/LV-2

Each of the above operations is done in sequence by a single task/process.

Step 3

S1/d5/m2/LV-3->S1/d1/m1/LV-3
S1/d6/m2/LV-3->S1/d2/m1/LV-3
S1/d7/m2/LV-3->S1/d3/m1/LV-3
S1/d8/m2/LV-3->S1/d4/m1/LV-3
S2/d5/m2/LV-3->S1/d1/m1/LV-3
S2/d6/m2/LV-3->S/d2/m1/LV-3
S2/d7/m2/LV-3->S1/d3/m1/LV-3
S2/d8/m2/LV-3->S1/d4/m1/LV-3
. . .
S4/d5/m2/LV-3->S4/d1/m1/LV-3
S4/d6/m2/LV-3->S4/d2/m1/LV-3
S4/d7/m2/LV-3->S4/d3/m1/LV-3
S4/d8/m2/LV-3->S4/d4/m1/LV-3

Each of the above operations is done in sequence by a single task/process. It is possible to reorder the above process in any manner without loss of performance. That is, step 1, 2 and 3 may be reordered as step 2, 3 and 1. As discussed above, a stripe in this case is a series or sequence of (four) data blocks striped across four physical disks. That is, in terms of contiguous data blocks, data block 1 is on Disk-5, data block 2 is on Disk-6, data block 3 is on Disk-7 and data block 4 is on Disk-8. Thus the act of copying Stripe 1 corresponds to sequentially copying block 1/Disk-5 to Disk-1, block2/Disk-6 to Disk-2, block3/Disk-7 to Disk-3 and block4/Disk-8 to Disk-4. This corresponds to the first four sequential separate copying processes in Step 1 above.

Thus the prior art method ‘steps’ sequentially across the disk array copying block 1 (on disk-5) to block 1 (on disk-1), then block 2 (on disk-6) to block 2 (on disk-2), then block 3 (on disk-7) to block 3 (on disk 3) then finally block 4 (on disk-8) to block 4 (on disk-4). This completely mirrors Stripe 1 between the disk arrays 1-4 and 5-8.

Therefore, it can be seen that there are relatively substantial disk head seeking times involved in applying the prior art technique to the synchronization of striped and mirrored logical volumes.

Referring again to the combined mirroring/striping situation shown in FIG. 3 if we consider logical volume 1 (LV-1), the data belonging to this volume has 10 stripes. Stripe 1 of LV-1 corresponds to consecutive data blocks spread, or striped, across physical disks, Disk-1 to Disk-4. Thus, mirror-1 of LV-1 (the original data) consists of ten stripes spread across four disks. This data is then mirrored (the secondary or backup data) on disks Disk-5 through Disk-8 as mirror-2.

Similarly, LV 2 consisting of stripes S1 to S6 is spread across disks Disk-1 to Disk-4 as mirror-1 and is replicated across disks Disk-5 to Disk-8. Stripes S1 to S4 of logical volume 3 is similarly striped and mirrored across disks Disk-1 to Disk-4 and Disk-5 to Disk-8 respectively.

According to an exemplary embodiment, the invention performs the copy of synchronization process more efficiently whereby that data is copied from a plurality of first discrete physical storage means, in the form of disks, to a plurality of second discrete physical storage means, again in the form of disks. The data is split, or striped, across the plurality of first discrete physical storage means or disks. The blocks of the split data are copied in parallel between a plurality of pairs of the first discrete physical storage means and corresponding second discrete storage. However, the copying is performed in such a way that there is no more than one copy process occurring in respect of any single pair of first and second physical storage unit at any one time, i.e., the copying occurs in a non-overlapping manner.

Thus, in one exemplary embodiment, the invention provides a method of performing a synchronizing operation for the logical volumes by performing parallel synchronization of the stripes on each of the disks for every LV in a non-overlapping manner. It is noted that the invention contemplates the term ‘re-synchronization’, being the process whereby already synced data is duplicated or checked against counterpart data.

The degree of parallelism, or in other words, the number of parallel resynchronization tasks/processes per LV is equal to the number of Disks over which each stripe is spread/distributed. Thus, in the example shown in FIG. 3, the degree of parallelism is four and four simultaneous copy/write processes are performed at once. The degree of parallelism and thereby the efficiency of synchronization increases as the data is spread across more disks. The non-overlapping manner implies that the synchronization operations will be started and carried out in an order than ensure that no two LV synchronization operations involve the same disk. Put another way, LV synchronization processes that involve unrelated disks will run in parallel.

Thus, according to an embodiment of the invention and with reference to FIG. 3, the synchronization of LV-1 is followed by the synchronization of LV-2 followed by LV-3. That is (following the previously specified nomenclature):

Step 1:

S1-S10/d5/m2/LV-1->S1-S10/d1/m1/LV-1
S1-S10/d6/m2/LV-1->S1-S10/d2/m1/LV-1
S1-S10/d7/m2/LV-1->S1-S10/d3/m1/LV-1
S1-S10/d8/m2/LV-1->S1-S10/d4/m1/LV-1
   Step 2:
S1-S6/d5/m2/LV-2->S1-S6/d1/m1/LV-2
S1-S6/d6/m2/LV-2->S1-S6/d2/m1/LV-2
S1-S6/d7/m2/LV-2->S1-S6/d3/m1/LV-2
S1-S6/d8/m2/LV-2->S1-S6/d4/m1/LV-2
   Step 3:
S1-S4/d5/m2/LV-3->S1-S6/d1/m1/LV-3
S1-S4/d6/m2/LV-3->S1-S6/d2/m1/LV-3
S1-S4/d7/m2/LV-3->S1-S6/d3/m1/LV-3
S1-S4/d8/m2/LV-3->S1-S6/d4/m1/LV-3

Each of the operations in Steps 1, 2 and 3 is done in parallel by a separate task/process. The mirror synchronization process for LV-1, 2 and 3 is complete once each of the parallel tasks/processes shown in the above Step are completed. The individual block level copying steps making up the copying of a stripe as well as the order of the steps above can be reordered in any fashion without loss of performance, that is, the sequence may be Step 1, Step2 then Step3 or Step 2, Step 1 then Step3.

At a block level, the synchronization process is as follows. Stripe 1 is copied by simultaneously copying block 1 on Disk-5, block 2 on Disk-6, block 3 on Disk-7 and block 4 on Disk-8 to their respective mirror locations on Disk-1, 2, 3 and 4. Put another way, stripes 1 to 10 on Disks-5 to 8 are simultaneously copied to their mirrored location on Disks-1 to 4.

This exploits the fact that the read/write heads on Disk 5, 6, 7 and 8 (and 1, 2, 3, 4) are physically decoupled. That is, they are not on the same physical disk. So, for example the read/write steps between Disk-5 and Disk-1 can proceed completely independently of the other read/write processes between the other disk pairs.

Further, as noted above the actual block order of the read/write processes, could be done in reverse or even randomly for any given disk mirror pair (i.e., Disk-5/Disk-1 or Disk-7/Disk-3). That is, the specific order of copying the individual block of data for Stripes 1 to 10 on each individual disk pair does not really matter as the task for each physical disk is to copy the block data corresponding to the element of the each Stripe to its corresponding location on its corresponding mirror. The other logical volumes are copied in a similar manner and it is immaterial as to the order in which the copying occurs between decoupled physical disks. The specific order may further be configured so, that the blocks which are copied are scattered over the physical disk, thereby statistically distributing the copying process over the surface of the disk. This presupposes that block-level failure would occur with even probability over the disk.

Introducing parallelization in the read/write copying between uncoupled disk pairs represents a significantly faster method for synchronizing mirrored/striped disk arrays.

Thus, this embodiment of the invention syncs the mirrored/striped LVs in a significantly more efficient manner than in known methods.

In contrast, existing methods perform synchronization or mirrored/striped volume recovery by having a single process per volume performing the synchronization sequentially in a non-overlapping manner. That is, by syncing in an order that prevents two concurrent operations from involving the same disk.

In contrast, the invention synchronizes by performing a parallel synchronization of the stripes on each disk in a non-overlapping manner. This improves the synchronization performance and provides significant efficiency improvements as the number of separate physical disks increases as this increases the parallelism of the system. The non-overlapping constraint requires that the synchronization operations are started in an order that ensure that no two LV synchronization operations involve the same disk. Operations involving unrelated disks run in parallel.

Thus, if there are n disks over which each mirror in a logical volume is striped, the invention can provide a performance benefit over existing solutions by a factor of n as measured by the mirror synchronization time. This results in a very rapid creation of mirror copies for a logical volume. This reduces considerably the time that the mirror copies are offline for maintenance and data backup purposes as this is the period during which the disk array is most susceptible to a single point of failure.

Also, when offline copies are reattached to the logical volume after such maintenance activities, their contents must be resynchronized with the current copies of the data in the logical volume before the previously offline copy can be brought fully online. Again, the time period for which the resynchronization process occurs to move the offline mirror copy to an online mirror copy represents the vulnerability period and can result in a single point of failures during that period particularly in the case of a two-way mirrored volume.

The invention considerably reduces this vulnerability period and consequently reduces the risk of single point of failure by performing mirror synchronization considerably faster.

Further, following a system crash or an unclean shutdown, mirror copies must be resynchronized before the data on the mirrors can be made available for user applications. The invention therefore allows rapid re-establishment of data consistency by bringing mirror copies online faster than in existing methods in the art.

Although the invention has been described by way of example and with reference to particular embodiments it is to be understood that modification and/or improvements may be made without departing from the scope of the appended claims.

Where in the foregoing description reference has been made to integers or elements having known equivalents, then such equivalents are herein incorporated as if individually set forth.

1. A method of copying data from a plurality of first discrete physical storage means to a plurality of second discrete physical storage means, where the data is split across the plurality of first discrete physical storage means, the method comprising the steps of:
copying blocks of the split data in parallel between a plurality of pairs of said first and second discrete physical storage means, wherein the copying is performed in such a way that there is no more than one copy process occurring in respect of any single pair of first and second physical storage unit at any one time.

2. A method as claimed in claim 1 wherein the data is split into blocks, each consecutive block stored on a separate discrete physical storage means.

3. A method as claimed in claim 2, wherein the blocks stored on any one first physical storage means are copied consecutively to a corresponding second physical storage means.

4. A method as claimed in claim 2 wherein the blocks stored on any one first physical storage mans are copied in a random order to a corresponding second physical storage means.

5. A method as claimed in claim 2 wherein the blocks stored on any one first physical storage mans are copied in an order optimized according to the physical characteristics of the storage means, to a corresponding second physical storage means.

6. A method as claimed in claim 1 wherein the physical storage means are hard disks.

7. A method as claimed in claim 2 wherein a group of specified group of blocks corresponds to a logical volume.

8. A method as claimed in claim 7 wherein a logical volume is spread across a plurality of physical storage means.

9. (canceled)

10. (canceled)

11. A method as claimed in claim 7 wherein the plurality of first storage means stores a plurality of logical volumes.

12. A method as claimed in claim 1 wherein the copying step occurs so that the data stored on the plurality of second storage means is mirrored on the plurality of first storage means.

13. A method of providing redundant data storage comprising the method of claim 1 applied to arrays of hard disks.

14. The method of claim 1 applied to maintaining data consistency in a striped and mirrored disk array.

15. A method of synchronizing data in a disk array wherein upon loss of one or more units of data at a storage location on a discrete storage means, backup data is copied to said storage location in accordance with claim 1.

16. A disk array configured to operate in accordance with the method of claim 1.

17. A computer program adapted to operate a storage array in accordance with the method of claim 1.

18. A data carrier adapted to store a computer program as claimed in claim 17.

19. A method of mirroring striped data from two or more first hard disks to two or more corresponding second hard disks comprising simultaneously copying blocks of data between a plurality of first and second disk pairs so that each copying process between any pair of first and second disks is physically decoupled.
